(19) United States
(12) Patent Application Publication
(10) Pub. No.: US 2019/0308228 A1
(43) Pub. Date: Oct. 10, 2019

(54) SYSTEM AND METHOD FOR CLEANING STEAM GENERATORS

(71) Applicant: A.J.Antines & Co., Carol Stream, IL (US)

(72) Inventors: Joseph R. Clark, Naperville, IL (US); James Buchler, Orland Park, IL (US); Joseph C. Frankiewicz, Schaumburg, IL (US); Ted R. Mila, Elburn, IL (US); William Brach, Cary, IL (US); Dale A. Squier, N.Oswego, IL (US)

(21) Appl. No.: 16/365,225

(22) Filed: Mar. 26, 2019

Related U.S. Application Data
(60) Provisional application No. 62/653,598, filed on Apr. 6, 2018.

(51) Int. Cl. B08B 9/032; B08B 3/08; B08B 3/10; F24C 15/00

(52) U.S. Cl. CPC B08B 9/0325; B08B 3/08; B08B 2209/032; F24C 15/003; B08B 3/108

(57) ABSTRACT

A system and method for cleaning steam generators is disclosed as comprising a housing disposed within the steam generator, a cartridge removably disposed within the housing, deliming crystals disposed within the cartridge, a water inlet port fluidically connected to the housing for permitting water to enter the housing and the cartridge so as to mix with the deliming crystals so as to form a deliming crystalline solution, a water exit port fluidically connected to the housing for permitting the deliming crystalline solution to flow out from the housing, and a control system operatively connected to the housing and to the source of water so as to control water fill and drain cycles throughout the steam generator so as to permit the deliming crystalline solution to flow through the steam generator, delime the valves, valve seats, and water fill probes, and be drained out from the steam generator upon completion of the cleaning operation. A graphical user interface (GUI) is also provided upon the steam generator so as to sequentially assist the operator in performing the necessary steps of the cleaning operation.

### CROSS REFERENCE TO RELATED APPLICATIONS

The present invention is a non-provisional patent application which is effectively a non-provisional patent application conversion from U.S. Provisional Patent Application, Application No. 62/653598 which was filed in the United States Patent Office on Apr. 6, 2018, and from which the priority benefits of which are hereby claimed.

### FIELD OF THE INVENTION

The present invention relates generally to food service equipment, and more particularly to a system and method for cleaning steam generators which are utilized in connection with the steam cooking of food items.

### BACKGROUND OF THE INVENTION

In connection with the use of various cooking procedures or techniques employed in connection with the preparation of various food products, particularly within fast-food restaurants, steam cooking has proven to be an extremely efficient cooking method. One major problem, however, with utilizing steam cooking as means for cooking various food items is the fact that the quality of water that exists in various parts of the United States, and certainly throughout various parts of the world, varies widely. Accordingly, while boiler-based systems, for generating the steam to be utilized within the steam cooking operations, are desirable food-cooking systems, they require frequent routine cleaning and maintenance in order to ensure that the systems operate for long periods of time without requiring substantial maintenance, repair, replacement of operating components, and the like, by qualified service technicians. These events cannot only be costly, but more importantly, will result in down-time of the systems whereby the steam cooking operations for the fast-food restaurants cannot be achieved when desired or needed in order to satisfy food patron orders.

Still further, it has also been noted that one of the most significant problems encountered within conventional boiler-based systems resides in the fact that such systems do not actually address the two, most common problem areas within the system which are the various valve seats operatively associated with the various valves which control the various water fluid-flow routes defined within the system in order to permit the desired filling and draining of the various compartments throughout the system, and the water level probes which control the proper fill rates of the various compartments of the system with water in order to ensure or maintain proper thermal efficiencies. Without proper cleaning, water scale or lime scale, and/or other debris buildup, which naturally occurs over time from the water commonly used within boiler-based steam cooking equipment, and which actually comprise deposits of calcium and magnesium, will tend to build up and accumulate upon various working component parts of the system so as to eventually lead to improper operation of the various component parts of the system.

A need therefore exists in the art for a new and improved system and method for cleaning steam generators. Another need exists in the art for a new and improved system and method for cleaning steam generators wherein the system and method are simple and easy to accomplish. Still another need exists in the art for a new and improved system and method for cleaning steam generators wherein the system and method are simple and easy to accomplish, and wherein the system and method runs automatically. Yet another need exists in the art for a new and improved system and method for cleaning steam generators wherein the system and method are simple and easy to accomplish, and wherein the system and method runs automatically such that if conducted periodically as prescribed, the need for external maintenance personnel, and/or repair and replacement of component parts, will effectively be eliminated. Still yet another need exists in the art for a new and improved system and method for cleaning steam generators wherein the system and method are simple and easy to accomplish, wherein the system and method runs automatically such that if conducted periodically as prescribed, the need for external maintenance personnel, and/or repair and replacement of component parts, will effectively be eliminated, and wherein the cleaning operation has been specifically developed to attack or address conventionally difficult, and usually ignored, problem areas within boiler-based steam cooking apparatus. Yet still another need exists in the art for a new and improved system and method for cleaning steam generators wherein the system and method are simple and easy to accomplish, wherein the system and method runs automatically such that if conducted periodically as prescribed, the need for external maintenance personnel, and/or repair and replacement of component parts, will effectively be eliminated, and wherein the cleaning operation has been specifically developed to attack or address conventionally difficult, and usually ignored, problem areas within boiler-based steam cooking apparatus, wherein, for example, such known problem areas are the various valve seats operatively associated with the various valves which control the fluid flow of the water to various destinations throughout the system, as well as the water level probes of the system which control the proper fill rates or water levels within the various compartments of the system in order to maintain proper thermal efficiencies.

### OVERALL OBJECTIVES OF THE INVENTION

Therefore, an overall objective of the present invention is to provide a new and improved system and method for cleaning steam generators. Another overall objective of the present invention is to provide a new and improved system and method for cleaning steam generators wherein the system and method are simple and easy to accomplish. Still another overall objective of the present invention is to provide a new and improved system and method for cleaning steam generators wherein the system and method are simple and easy to accomplish, and wherein the system and method runs automatically. Yet another overall objective of the present invention is to provide a new and improved system and method for cleaning steam generators wherein the system and method are simple and easy to accomplish, and wherein the system and method runs automatically such that if conducted periodically as prescribed, the need for external maintenance personnel, and/or repair and replacement of component parts, will effectively be eliminated. Still yet another overall objective of the present invention is to provide a new and improved system and method for cleaning steam generators wherein the system and method are simple and easy to accomplish, wherein the system and method runs automatically such that if conducted periodically as prescribed, the need for external maintenance personnel, and/or repair and replacement of component parts, will effectively be eliminated, and wherein the cleaning operation has been specifically developed to attack or address conventionally difficult, and usually ignored, problem areas within boiler-based steam cooking apparatus. Yet still another overall objective of the present invention is to provide a new and improved system and method for cleaning steam generators wherein the system and method are simple and easy to accomplish, wherein the system and method runs automatically such that if conducted periodically as prescribed, the need for external maintenance personnel, and/or repair and replacement of component parts, will effectively be eliminated, and wherein the cleaning operation has been specifically developed to attack or address conventionally difficult, and usually ignored, problem areas within boiler-based steam cooking apparatus, wherein, for example, such known problem areas are the various valve seats operatively associated with the various valves which control the fluid flow of the water to various destinations throughout the system, as well as the water level probes of the system which control the proper fill rates or water levels within the various compartments of the system in order to maintain proper thermal efficiencies.

### SUMMARY OF THE INVENTION

The foregoing and other objectives are achieved in accordance with the principles and teachings of the present invention which is concerned with a new and improved method for cleaning steam generators, and to apparatus for achieving the same. More particularly, the apparatus comprises a tubular housing into which a removable cartridge is inserted. The cartridge has a plurality of screen sections defined therein, and is adapted to hold a predetermined amount of deliming crystals which could be, for example, citric acid crystals. Of course, other deliming or cleaning chemicals or products can be used, such as, for example, various deliming bleach crystals, deliming chemical sticks, deliming liquids, bleaches, and the like. Water is conducted into the housing, through means of a solenoid-controlled valving system, and flows through the cartridge containing the deliming crystals or other chemicals as noted. The cartridge is provided with an end cap for sealing off the open end of the cartridge after the crystals have been deposited into the cartridge, and the end cap is fitted to the end portion of the cartridge by means of SAE (Society of Automotive Engineers) threads which render the attachment and detachment of the end cap onto and off from the cartridge relatively easy. The end cap includes, for example, a square-shaped key-hole within which a corresponding square-shaped key is to be inserted so as to quickly and easily tighten the end cap onto the cartridge as well as to remove the end cap from the cartridge. Alternatively, in lieu of the SAE threads, quarter-turn fasteners may be utilized, or still further, a bayonet connection may be utilized.

The cleaning process is entirely automated and operated from a GUI (Graphical User Interface) which initiates the cleaning cycle, permits the water to enter the bottom of the steam generator so as to fill the steam generator from the bottom upwardly. This is in contrast to conventional steam generator cleaning processes which effectively clean their systems by means of a gravity-fed, top down operation. The crystalline solution is permitted to remain within the steam generator for a predetermined period of time, such as, for example, twenty (20) minutes, and is then drained. The filling and draining steps are then repeated several times. The crystalline solution removes unwanted lime deposits from the valve seats, temperature probes, water probes, heaters, and, other operative structures comprising the steam generator, while the repetitive filling and draining effectively flushes the delimed deposits out from the steam generator. Software-controlled procedures also periodically cause the valve mechanisms to be rattled or oscillated upon their valve seats so as to also assist in the deliming of the valves and the valve seats. In addition, pH or other similar testing can also be conducted upon the water both before and after the treatment process so as to effectively determine optimum cleaning cycles, frequency, and duration, as well as to ensure that no deliming residue remains within the system. Such variations in cleaning cycle times, frequency, and duration can be controlled by means of the GUI (Graphical User Interface) and the proprietary software incorporated within the system.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of a steam generator, such as, for example, a mini-steam generator which is capable of being mounted upon a countertop of a fast-food establishment, wherein the removable cartridge, housing the citric acid deliming crystals, is shown as being removably attached to a housing canister of the steam generator as a result of being insertable into and withdrawn from the housing canister in connection with the performance of a steam generator cleaning operation;

FIG. 2 is an exploded view of the steam generator illustrating the mounting of the removable cartridge, housing the citric acid deliming crystals, as inserted within the housing canister of the steam generator, and how the cartridge can be removed from the housing canister of the steam generator by means of a special clean cycle key whereby the cartridge can be loaded with the deliming crystals in preparation for the performance of a steam generator cleaning operation;

FIG. 3 is a schematic view showing steam generator personnel pouring deliming crystals into the removable cartridge in preparation for the same for being inserted into the steam generator housing canister in preparation for the performance of a steam generator cleaning operation;

FIG. 4 is an enlarged perspective view of the cartridge, for containing the deliming crystals, as being mounted within the steam generator canister, and wherein the canister is operatively connected to both the incoming water supply conduit as well as an exit port through which the deliming crystal solution will pass on its way to the drain portion of the steam generator from where the deliming crystal solution will be routed throughout all regions of the steam generator in order to perform a cleaning operation upon all desired components of the steam generator;

FIGS. 5-7 schematically illustrate the graphical user interface (GUI) incorporated within a wall portion of the steam generator wherein the operation of the graphical user interface (GUI) by operator personnel assists the operator personnel in conducting the cleaning operation for the steam generator by sequentially displaying various, step-by-step instructions to the operator personnel in connection with conducting the cleaning operation upon the steam generator.

### DETAILED DESCRIPTION OF THE PREFERRED EMBODIMENT

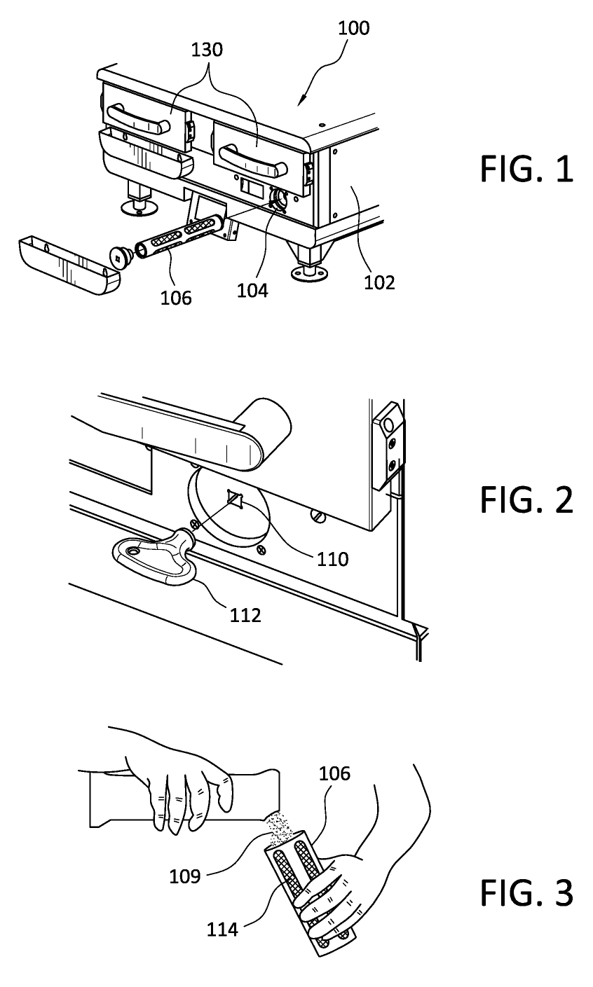

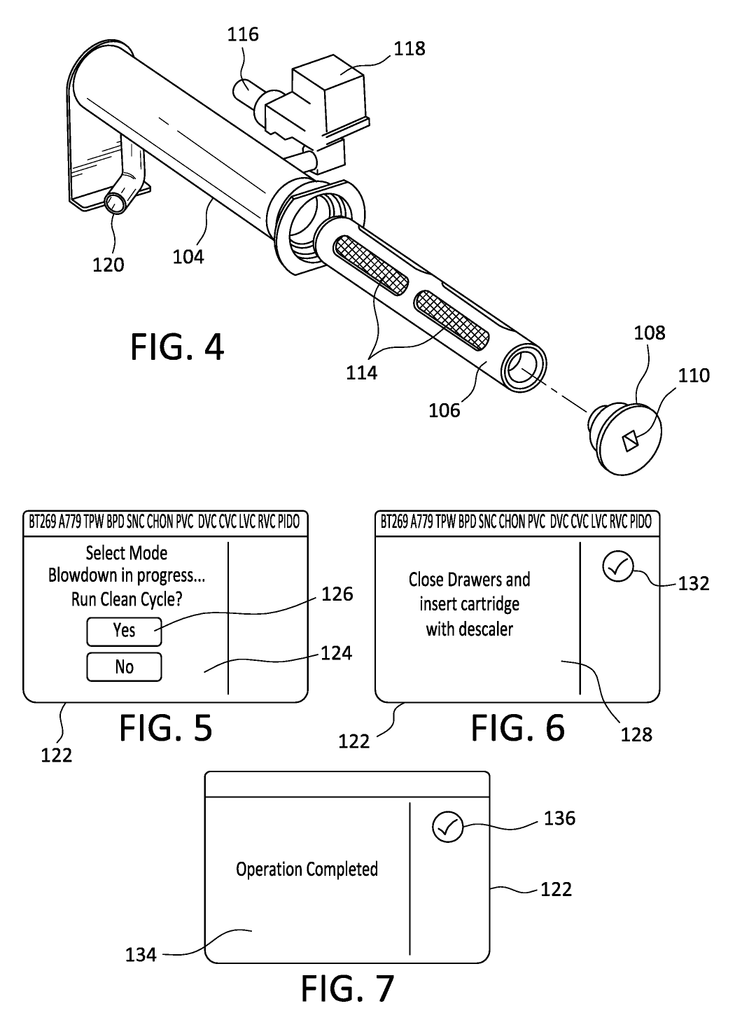

In accordance with the principles and teachings of the present invention, and with reference being made to FIGS. 1-4, a new and improved method for cleaning steam generators, and apparatus for achieving the same, is disclosed and is generally indicated by the reference character 100. More particularly, the apparatus 100 is seen to comprise a steam generator 102 within which a tubular canister or housing 104 is provided for accommodating a removable cartridge 106. As can best be seen from FIG. 4, the cartridge 106 comprises a tubular housing which is closed at its rear end, that is, the end that will be inserted first into the tubular canister or housing 104, while the oppositely disposed forward end of the cartridge 106 has a cap 108 removably mounted thereon such that when the cap 108 is removed from the cartridge 106, deliming crystals 109 may be poured into the cartridge 106 as illustrated within FIG. 3. The end cap 108 is provided with SAE (Society of Automotive Engineers) threads which render the attachment and detachment of the end cap 108 from the open end of the cartridge 106 relatively easy, although, alternatively, in lieu of the SAE threads, quarter-turn fasteners or bayonet connections may be utilized. It is also seen that the end cap 108 is provided with a substantially square-shaped female keyhole 110 within which a square-shaped male member, formed upon a key 112, can be inserted so as to remove the cartridge 106 from the tubular canister or housing 104, as illustrated within FIG. 2, or alternatively, to install the cartridge 106 into the tubular canister or housing 104.

The deliming crystals could be, for example, citric acid crystals, although, of course, other deliming or cleaning chemicals or products can be used, such as, for example, various deliming bleach crystals, deliming chemical sticks, deliming liquids, bleaches, and the like. Side wall portions of the cartridge 106 comprise a plurality of screen sections 114, and it is seen that a water supply inlet conduit 116 is fixedly mounted upon a side wall portion of the tubular canister or housing 104, while a solenoid-controlled fill valve 118 is operatively associated with the water supply inlet conduit 112 so as to control the supply of water into the tubular canister or housing 104. In this manner, when the removable cartridge 106, having the deliming crystals loaded or charged therein, is inserted into the tubular canister or housing 104, water is conducted into the tubular canister or housing 104 and flows through the screen sections 114 of the removable cartridge 106 containing the deliming crystals or other chemicals so as to mix with the deliming crystals and dissolve the same. The tubular canister or housing 104 is also provided with an exit port 120 through which the cleaning solution, comprising the water and dissolved deliming crystals, can be discharged from the cartridge 106 and permitted to flow into the various water conduits and compartments of the steam generator 102 such that the deliming solution now flows throughout the steam generator 102 and can encounter all components of the steam generator 102 that need to be cleaned, such as, for example, the various valve seats of the various control or drain valves of the steam generator as well as the temperature probes, the water fill probes, heating elements, and other structural components of the steam generator 102 upon which scale deposits can accumulate. The exit port 120 is fluidically connected to the drain of the steam generator 102, and in this manner, it is to be noted that, contrary to conventional steam generator cleaning procedures which are effectively gravity-fed, top-down systems, the system 100 of the present invention feeds the steam generator 102 from the bottom upwardly so as to thereby ensure that all operative components of the steam generator 102 are in fact properly cleaned.

Having described substantially all of the operative components of the new and improved steam generator cleaning apparatus of the present invention, a typical cleaning operation cycle will now be described. More particularly, with reference being made to FIGS. 5-7, it is to be appreciated that the cleaning operation is entirely automated and operated from a GUI (Graphical User Interface) 122 which initiates the cleaning cycle so as to permit the water to enter the removable cartridge 106, mix with the deliming crystals 109 disposed within the removable cartridge 106, and flow into bottom of the steam generator 102 so as to fill the steam generator 102 from the bottom upwardly. When the steam generator 102 is shut down, such as, for example, at the end of a day's operation, the GUI (Graphical User Interface) 122 will display a screen 124, such as that illustrated within FIG. 5, whereby an operator is prompted to select conducting or initiating a CLEAN CYCLE. Upon depression of the YES button 126, the screen 128, as illustrated within FIG. 6, will be displayed which prompts the operator close all of the food drawers 130 of the steam generator 102 as are illustrated within FIG. 1. In addition, the operator is also prompted to remove the cartridge 106 from the steam generator 102 by using the key 112, fill the removable cartridge 106 with the deliming crystals 109, reinsert the cartridge 106, having the deliming crystals disposed therein, back into the steam generator 102 and tightening the installation of the cartridge 106 within the steam generator 102 by again using the key 112, and then depress a first check icon 132 upon the screen 128 so as to actually initiate the cleaning cycle. Upon initiation of the cleaning cycle or operation, software embodied within the steam generator will actuate various valve mechanisms, not shown, which will permit the deliming crystalline solution to flow into various sections, regions, or compartments of the steam generator such that the deliming crystalline solution will come into contact with all of the various operative components of the steam generator, such as, for example, the various valves, valve seats, water fill probes, temperature probes, and the like, so as to clean and delime the same.

The crystalline solution is permitted to remain within the steam generator for a predetermined period of time, such as, for example, twenty (20) minutes, and is then drained. In addition, the filling and draining steps may be repeated several times. The crystalline solution removes unwanted lime deposits from the valve seats, temperature probes, water fill probes, heaters, and other operative structures comprising the steam generator, while the repetitive filling and draining effectively flushes the delimed deposits out from the steam generator. Still further, software-controlled procedures also periodically cause the valve mechanisms to be rattled or oscillated upon their valve seats so as to also assist in the deliming of the valves and the valve seats. Still yet further, pH or other similar testing can also be conducted upon the water both before and after the treatment process so as to effectively determine optimum cleaning cycles, frequency, and duration, as well as to ensure that no deliming residue remains within the system. Such variations in cleaning cycle times, frequency, and duration can be controlled by means of the GUI (Graphical User Interface) and the proprietary software incorporated within the system. When the cleaning operation cycle is completed, a third screen 134 will appear upon the GUI (Graphical User Interface) 122 whereby the screen will inform the operator that the cleaning operation has been completed. At this time, a second check icon can be depressed whereby the GUI (Graphical User Interface) 122 will display a blank screen, or alternatively, may display a screen having a logo disposed thereon which is a brand logo for the particular food establishment.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Steam generator cleaning system

102—Steam generator

104—Tubular canister or housing for accommodating removable cartridge

106—Removable cartridge for containing deliming crystals

108—Removable end cap of cartridge 106

109—Deliming crystals

110—Square-shaped female hole within end of end cap 108

112—Key for insertion into hole 110

114—Screen sections of cartridge 106

116—Water inlet port

118—Solenoid controlled valve operative associated with water inlet port 116

120—Cleaning solution outlet port

122—Graphical user interface (GUI)

124—First screen to select cleaning cycle

126—YES button on screen 124 to select cleaning cycle

128—Second screen to prompt operator to fill cartridge with deliming crystals

130—Food drawers of steam generator

132—First check icon on screen 128 to initiate clean cycle

134—Third screen informing operator that the cleaning cycle is completed

136—Second check icon on screen 134

What is claimed as new and desired to be protected by letters patent, is:

1. A system for cleaning a steam generator having different structural components selected from the group comprising valves, valve seats, and water fill probes, and a drain system, comprising:
a housing disposed within said steam generator;
a cartridge removably disposed within said housing;
deliming crystals disposed within said cartridge;
a water inlet port fluidically connected to said housing for permitting water to enter said housing and said cartridge, and mix with said deliming crystals so as to form a deliming crystalline solution;
a water exit port fluidically connected to said housing for permitting said deliming crystalline solution to flow out from said housing; and
a control system operatively connected to said housing and said source of water so as to control water fill and drain cycles throughout said steam generator so as to permit said deliming crystalline solution to flow through said steam generator, delime said valves, valve seats, and water fill probes, and be drained out from said steam generator upon completion of a cleaning operation.

2. The system as set forth in claim 1, wherein:
said cartridge comprises a plurality of screen sections through which said deliming crystalline solution passes into said steam generator.

3. The system as set forth in claim 1, wherein:
said cartridge comprises an end cap which is removably attached to an open end of said cartridge through which said deliming crystals are deposited into said cartridge.

4. The system as set forth in claim 3, wherein:
said end cap is inserted upon and removed from said open end of said cartridge by SAE threads.

5. The system as set forth in claim 3, wherein:
said end cap is provided with a key hole within which a key is inserted so as to threadedly secure said end cap onto said open end of said cartridge and to remove said end cap from said open end of said cartridge.

6. The system as set forth in claim 1, wherein:
said water exit port of said housing is fluidically connected to said drain system of said steam generator such that said deliming crystalline solution fills said steam generator in a bottom-up mode.

7. The system as set forth in claim 1, further comprising:
a graphical user interface (GUI) for assisting operator personnel in operating said system for cleaning said steam generator by providing sequential informational screens telling operator personnel what to do in order to implement the operation of said system for cleaning said steam generator.

7. A method for cleaning a steam generator having different structural components selected from the group comprising valves, valve seats, and water fill probes, and a drain system, comprising the steps of:
providing a housing said steam generator;
removably disposing a cartridge within said housing;
filling said cartridge with deliming crystals;
providing said housing of said steam generator with a water inlet for permitting water to enter said housing and to mix with said deliming crystals disposed within said cartridge so as to form a deliming crystalline solution;
providing said housing with a water exit port for permitting said deliming crystalline solution to flow out from said housing; and
operatively running a control system within said steam generator so as to control water fill and drain cycles throughout said steam generator so as to permit said deliming crystalline solution to flow through said steam generator, delime said valves, valve seats, and water fill probes, and be drained out from said steam generator upon completion of a cleaning operation.

8. The method as set forth in claim 7, further comprising the step of:
after an initial deliming cycle, refilling and draining said steam generator multiple times.

9. The method as set forth in claim 7, wherein:
said filling of said steam generator with water is conducted from the bottom upwardly to a predetermined fill level at which said deliming crystalline solution can delime various structures of said steam generator selected from the group comprising water probes, temperature probes, valves, and valve seats.

10. The method as set forth in claim 7, further comprising the step of:
using a graphical user interface (GUI) for assisting operator personnel in operating said system for cleaning said steam generator by providing sequential informational screens telling operator personnel what to do in order to implement the operation of said system for cleaning said steam generator.
